(19) United States
(12) Patent Application Publication
(10) Pub. No.: US 2026/0319330 A1
(43) Pub. Date: Oct. 15, 2026

(54) LENS DRIVING APPARATUS AND CAMERA MODULE INCLUDING LENS DRIVING APPARATUS

(71) Applicant: SAMSUNG ELECTRO-MECHANICS CO., LTD., Suwon-si (KR)

(72) Inventors: Jae Ho BAIK, Suwon-si (KR); Jae Kyung KIM, Suwon-si (KR); Min Gyu KIM, Suwon-si (KR); Jae Sung OH, Suwon-si (KR)

(73) Assignee: SAMSUNG ELECTRO-MECHANICS CO., LTD., Suwon-si (KR)

(21) Appl. No.: 19/466,892

(22) Filed: Feb. 2, 2026

(30) Foreign Application Priority Data
Feb. 18, 2025 (KR) 10-2025-0020784
May 22, 2025 (KR) 10-2025-0066474

(51) Int. Cl. G03B 5/04

(52) U.S. Cl. CPC G03B 5/04; G03B 2205/0015; G03B 2205/0069

(57) ABSTRACT

A lens driving apparatus includes a lens module including a plurality of lenses; a carrier disposed in a housing and configured to move together with the lens module in an optical axis direction; a stopper coupled to the carrier; and a first ball member disposed between the housing and the carrier. The carrier includes a first sidewall extending in the optical axis direction, wherein the first ball member is disposed on the first sidewall; a second sidewall extending from the first sidewall, the second sidewall having one surface to which the stopper is coupled; and a reinforcing portion having an additional volume such that a thickness of a portion of the second sidewall to which the stopper is coupled is greater on a side closer to the first sidewall than on a side farther from the first sidewall.

### CROSS-REFERENCE TO RELATED APPLICATIONS

This application claims the benefit under 35 USC 119(a) of Korean Patent Application Nos. 10-2025-0020784 filed Feb. 18, 2025, and 10-2025-0066474 filed on May 22, 2025, in the Korean Intellectual Property Office, the entire disclosures of which are incorporated herein by reference for all purposes.

### BACKGROUND

### 1. Field

The present disclosure relates to a lens driving apparatus and a camera module including the same.

### 2. Description of the Background

Ultra-compact camera modules are adopted for use in mobile communication terminals such as smartphones, tablet PCs, and laptops.

As camera modules decrease in size, the length of a focus adjustment carrier may also decrease, which may cause issues in maintaining perpendicularity, such as tilting of a ball rolling portion due to coupling to other members.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens driving apparatus includes a lens module including a plurality of lenses; a carrier disposed in a housing and configured to move together with the lens module in an optical axis direction; a stopper coupled to the carrier; and a first ball member disposed between the housing and the carrier. The carrier includes a first sidewall extending in the optical axis direction, wherein the first ball member is disposed on the first sidewall; a second sidewall extending from the first sidewall, the second sidewall having one surface to which the stopper is coupled; and a reinforcing portion such that a thickness of a portion of the second sidewall to which the stopper is coupled is greater on a side closer to the first sidewall than on a side farther from the first sidewall.

The reinforcing portion may include a first chamfered surface oblique to one surface of the carrier on which the first ball member is disposed, and to another surface of the carrier to which the stopper is coupled.

The reinforcing portion may include a first reinforcing surface extending from one end of the reinforcing portion toward the housing; and a second reinforcing surface extending from the other end of the reinforcing portion toward the housing. The first reinforcing surface and the second reinforcing surface may be perpendicular to each other within the carrier.

The lens module may include a lens holder disposed on the carrier, and the lens holder may include a cutout portion opposing the reinforcing portion.

The cutout portion may include a second chamfered surface opposing the first chamfered surface.

In another general aspect, a lens driving apparatus includes a lens module including a plurality of lenses; a carrier disposed in a housing and configured to move together with the lens module in an optical axis direction; and a stopper coupled to the carrier. The carrier includes a rigid member disposed to at least partially overlap a portion of the carrier to which the stopper is coupled, the rigid member having an extension portion extending in the optical axis direction.

A material of the rigid member may have a higher structural rigidity than a material of the carrier.

The rigid member may include a bottom portion disposed on a bottom surface of the carrier. The extension portion may be bent and extend from the bottom portion in the optical axis direction.

A length of the extension portion in the optical axis direction may correspond to a length of the carrier extending from the bottom surface of the carrier in the optical axis direction.

The extension portion may be disposed to be spaced apart from each other in one direction, perpendicular to the optical axis direction. The extension portion may further include a plurality of extension portions disposed to be spaced apart from each other in another direction, perpendicular to both the optical axis direction and the one direction.

The stopper may be coupled to a stopper coupling portion disposed on the carrier. A length of the extension portion in a width direction, perpendicular to the optical axis direction, may be less than a length of the stopper coupling portion in the width direction.

The carrier may include a first ball rolling portion having a first ball member disposed between one surface of the housing and one surface of the carrier opposing each other. The stopper coupling portion may be disposed on the other surface of the carrier, adjacent to the one surface of the carrier. A center of the length of the extension portion in the width direction may be disposed to be away from the first ball rolling portion with respect to a center of the length of the stopper coupling portion in the width direction.

In another general aspect, a camera module includes a carrier accommodating a lens module; and a focus adjustment portion configured to drive the carrier in an optical axis direction. A first ball rolling portion and a stopper coupling portion may be disposed on different side surfaces of the carrier. The carrier includes a reinforcing portion disposed at an inner corner of the carrier at which the first ball rolling portion and the stopper coupling portion meet each other, and a rigid member having an extension portion disposed to at least partially overlap the stopper coupling portion.

The lens module may include a lens barrel in which a plurality of lenses are disposed, and a lens holder to which the lens barrel is coupled. The lens holder may include a cutout portion disposed to oppose the reinforcing portion.

The rigid member may include a metallic material and a bottom portion disposed on a bottom surface of the carrier. The extension portion may be bent and extended from the bottom portion in the optical axis direction.

A center of a length of the extension portion in a width direction, perpendicular to the optical axis direction, may be disposed to be away from the first ball rolling portion with respect to a center of a length of the stopper coupling portion in the width direction.

The camera module may further include an image stabilization portion configured to drive the lens module in a direction perpendicular to the optical axis direction.

The image stabilization portion may further include a plurality of coils disposed in the housing, and a plurality of electronic devices, and the plurality of electronic devices may include at least three position sensors.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIG. 2 is an exploded perspective view of a camera module according to an example embodiment of the present disclosure.

FIGS. 3A and 3B are perspective views of a carrier viewed in both directions according to an example embodiment of the present disclosure.

FIG. 4 is a partially enlarged view of a carrier according to an example embodiment of the present disclosure.

FIG. 5 is a partial projection view of the carrier according to another example embodiment of the present disclosure.

FIG. 6 is a partial projection view of a carrier according to an example embodiment of the present disclosure.

FIG. 7 is an exploded perspective view of a lens driving apparatus according to an example embodiment of the present disclosure.

FIG. 8 is a partially enlarged view of a lens holder according to an example embodiment of the present disclosure.

FIG. 9 is an assembled plan view and a partially enlarged view of a lens driving apparatus according to an example embodiment of the present disclosure.

FIG. 10 is a partially enlarged view of a carrier according to an example embodiment of the present disclosure.

FIG. 11 is a cross-sectional view taken along line I-I′ of FIG. 3A.

FIG. 12 is an exploded perspective view of a focus adjustment portion according to an example embodiment of the present disclosure.

FIG. 13 is a side view of a carrier according to another example embodiment of the present disclosure.

FIG. 14 is an exploded perspective view of an image stabilization portion according to an example embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

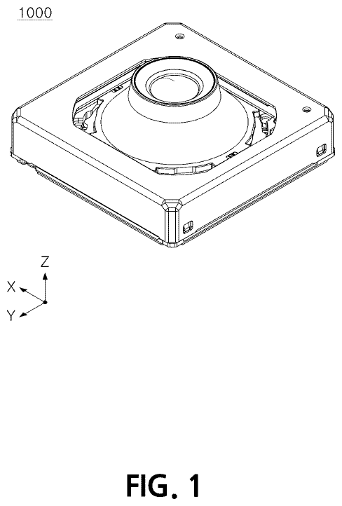

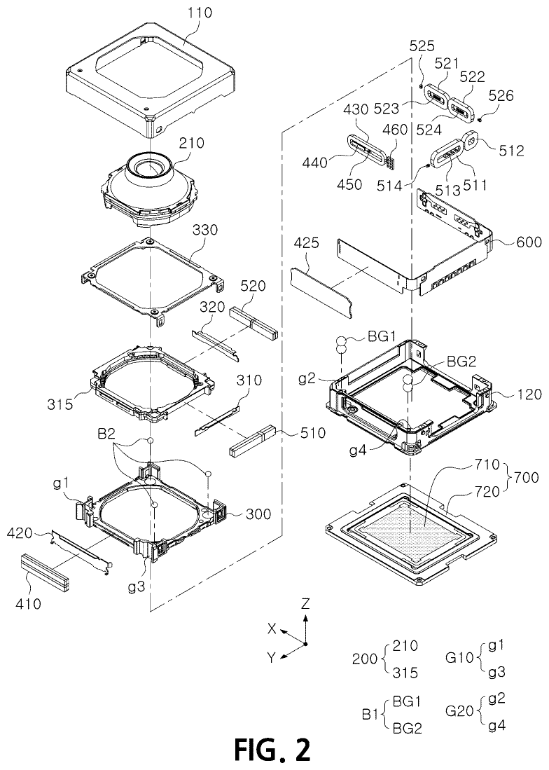

FIG. 1 may be a perspective view of a camera module 1000 according to an example embodiment of the present disclosure. FIG. 2 may be an exploded perspective view of the camera module 1000 according to an example embodiment of the present disclosure.

Referring to FIGS. 1 and 2, the camera module 1000 according to an example embodiment of the present disclosure may include a lens module 200, a lens driving apparatus moving the lens module 200, an image sensor module 700 converting light incident through the lens module 200 into an electrical signal, and a housing 120 and a case 110 accommodating the lens module 200 and the lens driving apparatus.

The lens module 200 may include a lens barrel 210.

The lens barrel 210 may have a hollow cylindrical shape so as to accommodate a plurality of lenses imaging a subject therein, and the plurality of lenses may be mounted in the lens barrel 210 along an optical axis.

The plurality of lenses may be disposed in a number desired according to a design of the lens barrel 210, and respective lenses may have the same or different optical characteristics, such as refractive index.

The lens driving apparatus may move the lens module 200.

The lens driving apparatus according to an example embodiment of the present disclosure may include a carrier 300 accommodating the lens module 200 and moving together with the lens module 200 in an optical axis direction, a first ball rolling portion G10 having a first ball member B1 disposed between the carrier 300 and the housing 120, and a stopper 330 coupled to an external surface of the carrier 300.

For example, the lens module 200 may include a lens barrel 210 in which the plurality of lenses are disposed in the optical axis direction, and a lens holder 315 on which the lens barrel 210 is mounted.

For example, the lens driving apparatus may adjust a focus by moving the lens module 200 in the optical axis direction. For example, the lens driving apparatus may stabilize an image during image capturing by moving the lens module 200 in a direction perpendicular to the optical axis.

That is, the camera module 1000 may include a focus adjustment portion adjusting a focus, and an image stabilization portion stabilizing an image.

An example embodiment of the present disclosure may include a stopper 330. The stopper 330 may prevent the lens module 200 from being detached from the carrier 300 by external impacts or the like, or may absorb impacts.

The image sensor module 700 may convert light incident through the lens module 200 into an electrical signal.

For example, the image sensor module 700 may include an image sensor 710, and a printed circuit board 720 electrically connected to the image sensor 710.

The image sensor module 700 may further include an infrared filter. The infrared filter may block a light beam within an infrared range, among light beams incident through the lens barrel 210.

The electrical signal, converted by the image sensor 710, may be output as an image through a display unit of a portable electronic device.

The image sensor 710 may be fixed to the printed circuit board 720, and may be electrically connected to the printed circuit board 720.

The lens module 200 and the lens driving apparatus may be accommodated in the housing 120.

For example, an upper portion and a lower portion of the housing 120 may have an open shape, and the lens module 200 and the lens driving apparatus may be accommodated in an internal space of the housing 120.

The image sensor module 700 may be disposed on the lower portion of the housing 120.

In addition, a substrate 600, providing a driving signal to the focus adjustment portion and the image stabilization portion, may be disposed on a side surface of the housing 120, and the substrate 600 may be provided as a single substrate surrounding a side surface of the housing 120.

As will be described below, the side surface of the housing 120 may have an opening to allow insertion of a driving coil 430 and a first electronic device portion 405 of the focus adjustment portion, and a plurality of coils and a second electronic device portion 505 of the image stabilization portion.

The case 110 may be coupled to the housing 120, and may perform a function of protecting internal components of the camera module 1000.

In addition, the case 110 may perform a function of shielding electromagnetic waves. For example, the case 110 may shield electromagnetic waves generated in the camera module 1000 so as to prevent the electromagnetic waves from affecting other electronic components in the portable electronic device.

For example, the case 110 may be formed of a metallic material, and may be grounded to a grounding pad provided on the printed circuit board 720, thereby shielding electromagnetic waves.

The lens module 200 may include a lens holder 315.

The lens holder 315 for image stabilization may be accommodated in the carrier 300. The lens barrel 210 may be mounted on the lens holder 315, such that the lens holder 315 and the lens barrel 210 may also move in the optical axis direction due to movement of the carrier 300. In this case, the lens holder 315 may move in both an X-axis direction and a Y-axis direction, perpendicular to the optical axis direction.

Details related to the driving of the focus adjustment portion and the image stabilization portion will be described below.

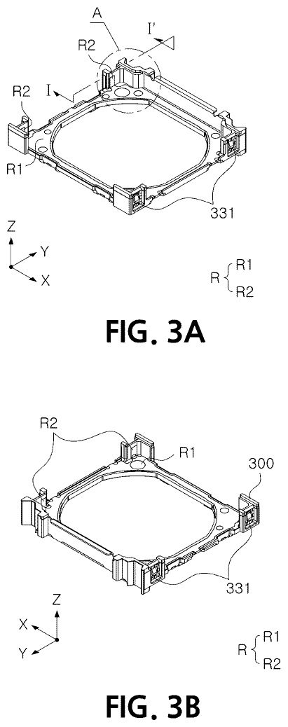

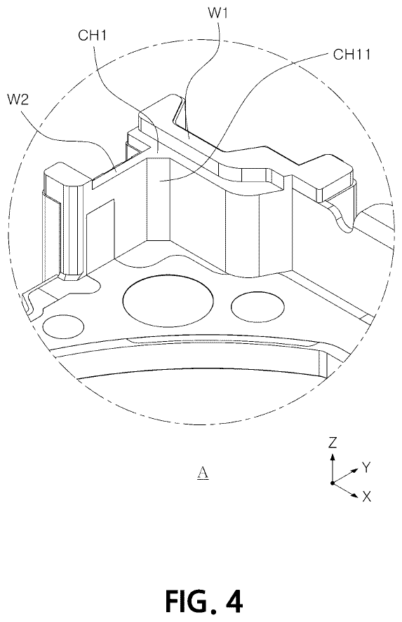

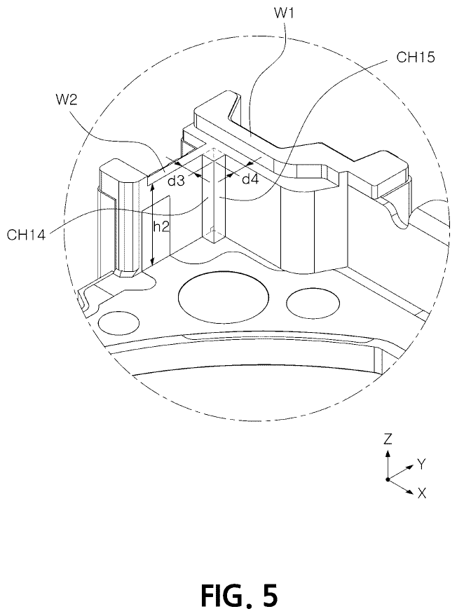

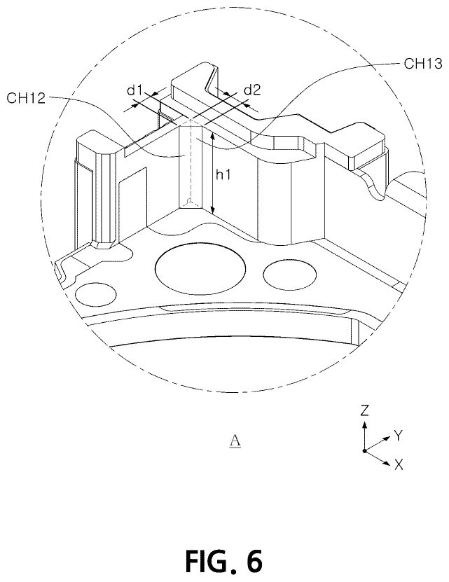

FIGS. 3A and 3B are perspective views of a carrier viewed in both directions according to an example embodiment of the present disclosure. FIG. 4 is a partially enlarged view of a carrier according to an example embodiment of the present disclosure. FIG. 5 is a partial projection view of the carrier according to another example embodiment of the present disclosure. FIG. 6 is a partial projection view of a carrier according to an example embodiment of the present disclosure.

The lens driving apparatus and the camera module 1000, including the same according to an example embodiment of the present disclosure, may include a carrier 300, and the carrier 300 may move together with the lens module 200 in the optical axis direction.

For example, the carrier 300 may include a stopper coupling portion 331 on one surface thereof opposing the housing 120, such that the stopper 330 partially covering the lens module 200 may be coupled to the carrier 300.

The stopper coupling portion 331 may be provided as a plurality of stopper coupling portions 331, and the plurality of stopper coupling portions 331 may be spaced apart from each other in a direction perpendicular to the optical axis.

A first ball rolling portion G10 capable of accommodating the first ball member B1 may be provided on the other surface of the carrier 300 rather than the one surface of the carrier 300 on which the stopper coupling portion 331 is provided.

The first ball rolling portion G10 may have a rail shape having a length in the optical axis direction.

The carrier 300 may have a length in the optical axis direction, and may have a first sidewall W1 on which the first ball member B1 is disposed.

The carrier 300 may have a second sidewall W2 extending from the first sidewall W1 in a direction perpendicular to the optical axis, the second sidewall W2 having a length in the optical axis direction. The stopper 330 may be coupled to the second sidewall W2.

The second sidewall W2 may have a stopper coupling portion 331 to which the stopper 330 is coupled, and the stopper coupling portion 331 may be thinner than other portions.

For example, a thickness of a portion of the second sidewall W2 of the carrier of the present disclosure to which the stopper 330 is coupled may be formed to be thicker on a side closer to the first sidewall W1.

That is, a reinforcing portion CH1 having an additional volume may be formed at an inner corner between the first sidewall W1 and the second sidewall W2. The reinforcing portion CH1 may be provided at a portion at which the first sidewall W1 and the second sidewall W2 are adjacent to each other.

As the reinforcing portion CH1 is provided, a thickness of the first sidewall W1 may increase in a direction toward the inside of the carrier 300. Similarly, a thickness of the second sidewall W2 may increase in a direction toward the inside of the carrier 300.

As the wall thickness of the carrier 300 increases, the rigidity of the carrier 300 may be further supplemented.

For example, as a distance from the first sidewall W1 decreases, the thickness of the second sidewall W2 may increase, and thus a reinforcing portion CH1 having an oblique shape may be provided at a corner portion of the carrier 300.

In other words, the reinforcing portion CH1 may be provided at an inner corner C at which one surface of the carrier 300 opposing the housing 120 with the first ball member B1 interposed therebetween meets the other surface of the carrier 300 to which the stopper 330 is coupled.

That is, the reinforcing portion CH1 may be provided at an inner corner of the carrier 300 at which the first ball rolling portion G10, provided on a side surface of the carrier 300, and the stopper coupling portion 331, provided on the other side surface of the carrier 300, meet each other.

For example, the reinforcing portion CH1 may be provided on at least two corners adjacent to the first ball rolling portion G10 and the stopper coupling portion 331, among the inner corners of the carrier 300.

For example, the reinforcing portion CH1 may be provided at all inner corner portions of the carrier 300.

For example, the thickness of the second sidewall W2 may increase as a distance from the first sidewall W1 decreases. In this case, the reinforcing portion CH1 may include a first chamfered surface CH11 opposing the lens holder 315 accommodated in the carrier 300. The first chamfered surface CH11 may have a substantially rectangular shape.

For example, the first chamfered surface CH11 may be oblique to one surface of the carrier 300 on which the first ball rolling portion G10 is provided. In addition, the first chamfered surface CH11 may be oblique to the other surface of the carrier 300 to which the stopper 330 is coupled.

The first chamfered surface CH11 may form a predetermined angle with the one surface of the carrier 300 opposing the housing 120. For example, the first chamfered surface CH11 may form an angle of about 45 degrees with the one surface of the carrier 300 opposing the housing 120.

For example, the reinforcing portion CH1 may include a first reinforcing surface CH12 extending from one end of the reinforcing portion CH1 toward the housing 120. In other words, the reinforcing portion CH1 may include a first reinforcing surface CH12 extending from one end of the first chamfered surface CH11 toward the housing 120.

The first reinforcing surface CH12 may be parallel to one surface of the carrier 300 including the stopper coupling portion 331.

In addition, the reinforcing portion CH1 may include a second reinforcing surface CH13 extending toward the housing 120 from the other end of the reinforcing portion CH1. In other words, the reinforcing portion CH1 may include a second reinforcing surface CH13 extending toward the housing 120 from the other end of the first chamfered surface CH11.

The second reinforcing surface CH13 may be parallel to the one surface of the carrier 300 on which the first ball rolling portion G10 is provided.

The first chamfered surface CH11 may be oblique to the first reinforcing surface CH12. Similarly, the first chamfered surface CH11 may be oblique to the second reinforcing surface CH13.

The first reinforcing surface CH12 and the second reinforcing surface CH13 may be perpendicular to each other within the carrier 300.

As the reinforcing portion CH1 is provided at an inner corner of the carrier 300, a wall thickness of the carrier 300 may increase.

For example, an inner wall thickness of the carrier 300 may increase in a first axis (X-axis) direction, perpendicular to the optical axis, from the first reinforcing surface CH12. In other words, the inner wall thickness of the carrier 300 may increase in the first axis (X-axis) direction from the second sidewall W2.

For example, the inner wall thickness of the carrier 300 may increase in a second axis (Y-axis) direction, perpendicular to the optical axis, from the second reinforcement surface CH13. In other words, the inner wall thickness of the carrier 300 may increase in the second axis (Y-axis) direction from the first sidewall W1.

That is, the wall thickness of the carrier 300 may increase toward rear surfaces of the first ball rolling portion G10 and the stopper coupling portion 331.

In this case, one of the inner corner portions of carrier 300 may have an increased volume of substantially {(a length (d1) of the first reinforcing surface CH12 in a width direction, perpendicular to an optical axis*a length (d2) of the second reinforcing surface CH13 in the width direction, perpendicular to the optical axis/2)*a height (h1) of the first chamfered surface CH11 in an optical axis direction from a bottom surface of carrier 300}.

As a result, a volume of carrier 300 may increase by four times the maximum above-described volume increase.

As the thickness of the carrier 300 increases toward the rear surfaces of the first ball rolling portion G10 and the stopper coupling portion 331 of the carrier 300, the rigidity of the carrier 300 may be supplemented.

Accordingly, even when the stopper 330 is coupled to the carrier 300, the perpendicularity of the first ball rolling portion G10 may be maintained.

That is, even when the stopper 330 is coupled to the carrier 300, the perpendicularity of the first ball rolling portion G10 may be maintained, thereby reducing the likelihood of a malfunction in the driving of focus adjustment (AF).

In addition, stress applied to the carrier 300 may be dispersed due to formation of an inclined reinforcing portion CH1 on an inner side of the carrier 300, on which one surface of the carrier 300 opposing the housing 120 meets the other surface of the carrier 300.

That is, the carrier 300 may be stably driven due to rigidity supplementation and stress dispersion due to an increase in the wall thickness of the carrier 300.

The shape of the reinforcing portion CH1 of the present disclosure is not limited to an example, and may be provided in another shape, as illustrated in FIG. 5.

Referring to FIG. 5, a thickness of a portion of the second sidewall W2 closer to the first sidewall W1 may be provided to be greater than a thickness of a portion of the second sidewall W2 farther from the first sidewall W1. However, as a distance between an increased portion of the second sidewall W2 and the first sidewall W1 gradually decreases, a thickness of the increased portion may remain constant rather than further increasing.

Even in this case, a reinforcing portion CH1 having an additional volume may be formed at an inner corner of the carrier 300 between the first sidewall W1 and the second sidewall W2. The reinforcing portion CH1 may be provided at a portion of the carrier 300 at which the first sidewall W1 and the second sidewall W2 are adjacent to each other.

As the reinforcing portion CH1 is provided, the thickness of the first sidewall W1 may increase toward the inside of the carrier 300. Similarly, the thickness of the second sidewall W2 may increase toward the inside of the carrier 300.

In another example embodiment of the present disclosure, the reinforcing portion CH1 may include a third reinforcing surface CH14 and a fourth reinforcing surface CH15.

The third reinforcing surface CH14 may be a surface vertically extending from the second sidewall W2. The fourth reinforcing surface CH15 may be a surface vertically extending from the first sidewall W1. The third reinforcing surface CH14 and the fourth reinforcing surface CH15 may be perpendicular to each other.

In this case, one of the inner corner portions of the carrier 300 may have an increased volume of substantially {(a length (d3) of the third reinforcing surface CH14 in a width direction, perpendicular to an optical axis*a length (d4) of the fourth reinforcing surface CH15 in the width direction, perpendicular to the optical axis)*a height (h2) of the second sidewall W2 in an optical axis direction from a bottom surface of carrier 300}.

As a result, a volume of carrier 300 may increase by four times the maximum above-described volume increase.

As a wall thickness of the carrier 300 increases, the rigidity of the carrier 300 may be further supplemented.

In other words, increasing the wall thickness of the carrier 300 enhances its rigidity, allowing it to be driven more stably. Accordingly, the likelihood of focus adjustment (AF) malfunctions is reduced.

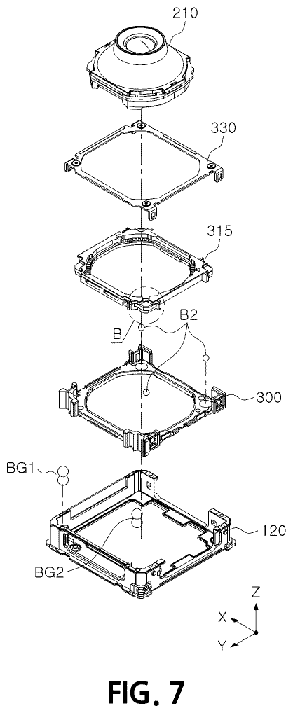

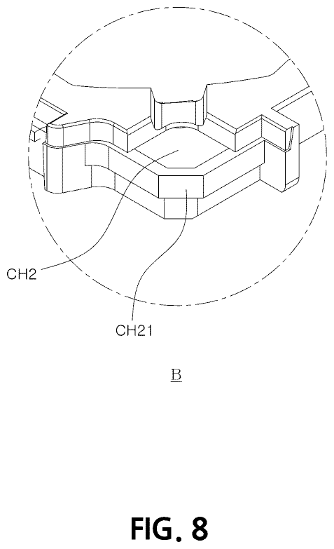

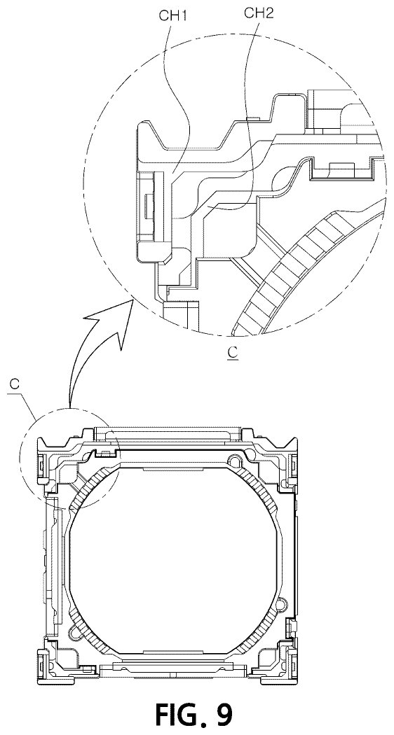

FIG. 7 is an exploded perspective view of a lens driving apparatus according to an example embodiment of the present disclosure. FIG. 8 is a partially enlarged view of a lens holder 315 according to an example embodiment of the present disclosure. FIG. 9 is an assembled plan view and a partially enlarged view of a lens driving apparatus according to an example embodiment of the present disclosure.

For example, a lens driving apparatus may include a carrier 300 and a lens holder 315 accommodated in the carrier 300.

The lens holder 315 may be accommodated in the carrier 300 in an optical axis direction. An internal surface of the carrier 300 and an external surface of the lens holder 315 may be disposed to oppose each other.

For example, the lens holder 315 may include a cutout portion CH2 opposing the reinforcing portion CH1. In the same manner as the reinforcing portion CH1, the cutout portion CH2 may have a substantially chamfered shape.

For example, the cutout portion CH2 may be provided at an outer corner of the lens holder 315 opposing each of two inner corners adjacent to the first ball rolling portion G10 and the stopper coupling portion 331, at least among inner corners of the carrier 300.

For example, the cutout portion CH2 may be provided at all outer corner portions of the lens holder 315.

The cutout portion CH2 may include a second chamfered surface CH21. The second chamfered surface CH21 may have a substantially rectangular shape.

The second chamfered surface CH21 may oppose the first chamfered surface CH11. In this case, the first chamfered surface CH11 and the second chamfered surface CH21 may be substantially parallel to each other.

For example, the second chamfered surface CH21 may be oblique to one surface of the lens holder 315 opposing the carrier 300 in a first axis (X-axis) direction, perpendicular to an optical axis. In addition, the second chamfered surface CH21 may be oblique to the other surface of the lens holder 315 opposing the carrier 300 in a second axis (Y-axis) direction, perpendicular to the optical axis.

The second chamfered surface CH21 may form an angle with the one surface of the lens holder 315 opposing the carrier 300 in the first axis (X-axis) direction or the second axis (Y-axis) direction, perpendicular to the optical axis. For example, the second chamfered surface CH21 may form an angle of about 45 degrees with the one surface of the lens holder 315 opposing the carrier 300 in the first axis (X-axis) direction or the second axis (Y-axis) direction, perpendicular to the optical axis.

As the carrier 300 includes the reinforcing portion CH1, an inner wall thickness of the carrier 300 may increase, which may limit a driving range of the lens holder 315 moving within the carrier 300.

In this case, as in an example embodiment of the present disclosure, as the lens holder 315 includes the cutout portion CH2, a cutout portion may be formed at a corner portion of the lens holder 315.

Due to formation of a cutout portion at the corner of the lens holder 315, the driving range of the lens holder 315 may be partially increased.

Accordingly, the lens holder 315 may be stably driven so as to minimize collision between the external surface of the lens holder 315 and the internal surface of the carrier 300.

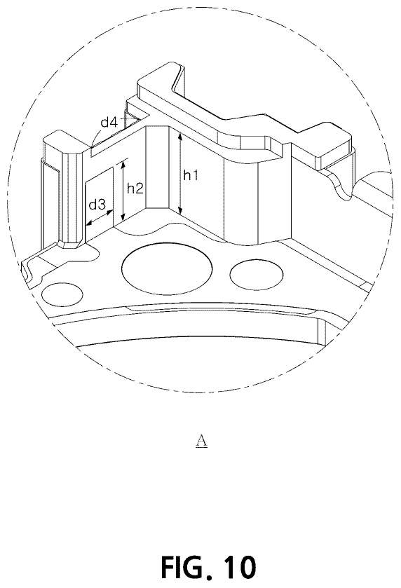

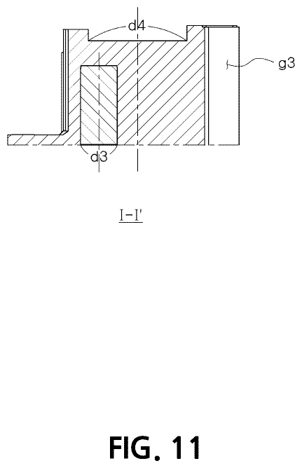

FIG. 10 is a partially enlarged view of a carrier 300 according to an example embodiment of the present disclosure. FIG. 11 is a cross-sectional view taken along line I-I′ of FIG. 3A.

A lens driving apparatus and a camera module 1000 including the same according to an example embodiment of the present disclosure may include a carrier 300, and the carrier 300 may include a rigid member R.

The rigid member R may be formed of a material different from that of the carrier 300. In this case, the rigid member R may be formed of a material having structural rigidity higher than that of the carrier 300.

For example, the rigid member R may be formed of a metal material. However, the material is not limited to a metal material.

The rigid member R may be provided in the carrier 300 by insert injection. That is, at least a portion of the rigid member R may be provided to overlap a portion of the carrier 300 to which a stopper 330 is coupled, but the present disclosure is not limited thereto. The rigid member R may be provided by being attached to the carrier 300.

The rigid member R may include a bottom portion R1 disposed on a bottom surface of the carrier 300 and an extension portion R2 extending from the bottom portion R1 in an optical axis direction.

The extension portion R2 may be provided to be bent and extend from the bottom portion R1 in an optical axis direction. That is, the rigid member R may be provided in the carrier 300 by insert injection, such that the bottom portion R1 and the extension portion R2 may be integrally formed.

As illustrated in FIGS. 3A and 3B, the extension portion R2 may be provided in the carrier 300 to be spaced apart in one direction, perpendicular to the optical axis direction, or may be provided to be spaced apart in another direction, perpendicular to both the optical axis direction and the one direction. That is, the extension portion R2 may be provided as a plurality of extension portions R2 at respective corners of the carrier 300.

The extension portion R2 may be provided in a position of the carrier 300 overlapping a stopper coupling portion 331 of the carrier 300. That is, the extension portion R2 may be provided to overlap one surface of the carrier 300 including the stopper coupling portion 331.

As the extension portion R2 is provided in a position of the carrier 300 overlapping the stopper coupling portion 331 of the carrier 300, the extension portion R2 may overlap a thin portion of the carrier 300, thereby supplementing rigidity of the carrier 300.

For example, a length (d4) of the stopper coupling portion 331 in a width direction, perpendicular to an optical axis, may be greater than a length (d3) of the extension portion R2 in the width direction, perpendicular to the optical axis.

The length (d3) of the extension portion R2 in the width direction may preferably be equal to or greater than half of the length (d4) of the stopper coupling portion 331 in the width direction.

For example, a length (h2) of the extension portion R2 in the optical axis direction may correspond to a length (h1) of the first chamfered surface CH11 in the optical axis direction from the bottom surface of the carrier 300.

For example, a center of the length (d3) of the extension portion R2 in the width direction may be disposed to be close to or away from the first ball rolling portion G10 with respect to a center of the length (d4) of the stopper coupling portion 331 in the width direction.

Preferably, as illustrated in FIG. 11, the center of the length (d3) of the extension portion R2 in the width direction may be disposed to be away from the first ball rolling portion G10 with respect to the center of the length (d4) of the stopper coupling portion 331 in the width direction.

As the extension portion R2 having higher rigidity may be provided to overlap the stopper coupling portion 331, which is a thinner portion of the carrier 300, rigidity of the carrier 300 may be supplemented.

In this case, even when the stopper 330 is coupled to the stopper coupling portion 331 of the carrier 300, perpendicularity of the first ball rolling portion G10 may be maintained.

That is, even when the stopper 330 is coupled to the carrier 300, perpendicularity of the first ball rolling portion G10 may be maintained, thereby reducing the likelihood of a malfunction in driving of focus adjustment (AF).

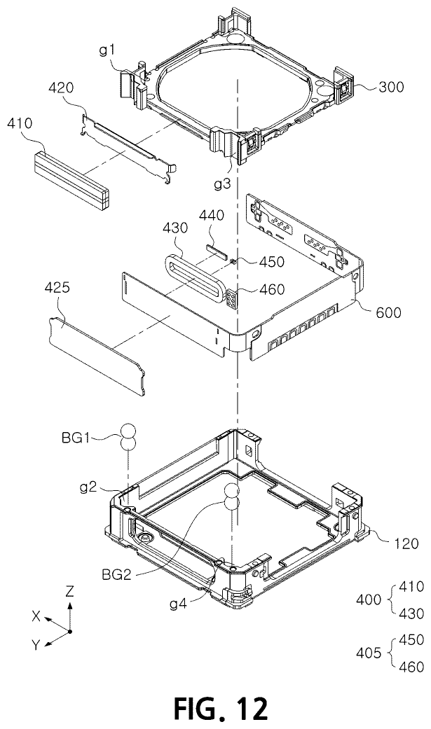

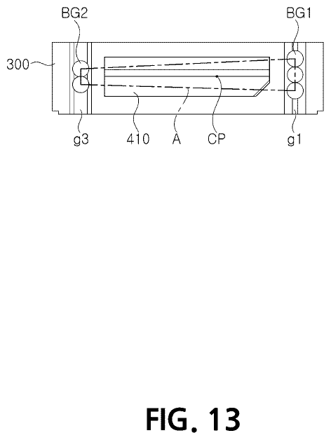

FIG. 12 is an exploded perspective view of a focus adjustment portion according to an example embodiment of the present disclosure. FIG. 13 is a side view of a carrier 300 according to another example embodiment of the present disclosure.

For example, the present disclosure may include a focus adjustment portion moving a lens module 200 in an optical axis direction.

The focus adjustment portion may include a carrier 300 accommodating the lens module 200, and a first driving portion 400 generating driving force to move the carrier 300 in the optical axis direction.

The first driving portion 400 may include a driving magnet 410 and a driving coil 430. The driving magnet 410 and the driving coil 430 may be disposed to oppose each other in a direction, perpendicular to an optical axis.

The driving magnet 410 may be disposed on the carrier 300. For example, the driving magnet 410 may be disposed on an external surface of the carrier 300. The driving magnet 410 may be disposed to overlap a second magnet 520 to be described below in one direction, perpendicular to the optical axis.

The driving magnet 410 may be disposed to oppose a first press 420 inserted into the carrier 300. For example, the driving magnet 410 may be in direct contact with the first press 420 and coupled to the first press 420.

The first press 420 may be formed of a magnetic material. Accordingly, attractive force may be generated between the first press 420 and the driving magnet 410.

The driving magnet 410 may be magnetized, such that one surface of the driving magnet 410 opposing the driving coil 430 may have both an N pole and an S pole. For example, on the one surface of the driving magnet 410 opposing the driving coil 430, an N pole, a neutral region, and an S pole may be sequentially magnetized in the optical axis direction.

The driving coil 430 may be a copper foil pattern in which a winding coil is attached to a substrate 600 or laminated and embedded in the substrate 600. The substrate 600 may be mounted on a side surface of the housing 120, such that the driving magnet 410 and the driving coil 430 may oppose each other in a direction, perpendicular to the optical axis.

During focus adjustment, the driving magnet 410 may be a moving member moving together with the carrier 300 in the optical axis direction, and the driving coil 430 may be a fixed member fixed to the substrate 600 and the housing 120.

When power is applied to the driving coil 430, electromagnetic force between the driving magnet 410 and the driving coil 430 may move the carrier 300 in the optical axis direction.

The focus adjustment portion may include a first yoke 425. The first yoke 425 may be disposed to oppose the driving magnet 410 in a direction perpendicular to the optical axis. For example, the first yoke 425 may be mounted on an outer surface of the substrate 600. Therefore, the first yoke 425 may be disposed to oppose the driving magnet 410 with the driving coil 430 interposed therebetween.

Attractive force may act between the first yoke 425 and the driving magnet 410 in a direction, perpendicular to the optical axis.

Accordingly, the first ball member B1 may maintain a contact state with the carrier 300 and the housing 120 by the attractive force between the first yoke 425 and the driving magnet 410.

In addition, the first yoke 425 may function to concentrate magnetic force of the driving magnet 410, thereby preventing generation of leakage magnetic flux.

For example, the first yoke 425 and the driving magnet 410 may form a magnetic circuit.

The focus adjustment portion may include a second yoke 440. The second yoke 440 may be disposed in a position of the focus adjustment portion opposing the driving magnet 410. For example, the second yoke 440 may be disposed to oppose the driving magnet 410 within the driving coil 430.

The second yoke 440 may be disposed eccentrically with respect to the driving magnet 410. For example, the second yoke 440 may be positioned to be close to a first groove g1 of the first ball rolling portion G10 of the carrier 300 to be described below. That is, the second yoke 440 may be positioned to be closer to a main rolling portion.

The second yoke 440 may be formed of a material capable of generating attractive force with respect to the driving magnet 410.

Accordingly, resultant force of attractive force between the driving magnet 410 and the first yoke 425 and attractive force between the driving magnet 410 and the second yoke 440 may act closer to the main rolling portion than to an auxiliary rolling portion.

For example, a support region A may be formed to be longer in the optical axis direction as a distance from the main rolling portion decreases. Accordingly, the second yoke 440 may be disposed to be closer to the main rolling portion, such that a central point CP of attractive force may be more stably positioned within the support region A.

Ball rolling portions may be disposed on surfaces of the carrier 300 and the housing 120 opposing each other. For example, a first ball rolling portion G10 may be disposed on one surface of carrier 300, and a second ball rolling portion G20 may be disposed on a surface of housing 120 opposing the one surface.

The first ball rolling portion G10 may include a first groove g1 and a third groove g3, and the second ball rolling portion G20 may include a second groove g2 and a fourth groove g4. Each groove may have a rail shape extending in the optical axis direction.

The first groove g1 and the second groove g2 may be disposed to oppose each other in a direction perpendicular to the optical axis. A first ball group BG1, a portion of the first ball member B1, may be disposed in a space between the first groove g1 and the second groove g2.

The first groove g1 and the second groove g2 may be included in the main rolling portion.

The first ball group BG1 and the main rolling portion may function as a main guide for guiding the movement of the carrier 300 in the optical axis direction.

The third groove g3 and the fourth groove g4 may be disposed to oppose each other in a direction perpendicular to the optical axis, and a second ball group BG2, a portion of the first ball member B1, may be disposed in a space between the third groove g3 and the fourth groove g4.

The third groove g3 and the fourth groove g4 may be included in the auxiliary rolling portion.

The second ball group BG2 and the auxiliary rolling portion may function as an auxiliary guide for supporting the movement of the carrier 300 in the optical axis direction.

Each of the first ball group BG1 and the second ball group BG2 may include a plurality of balls disposed in the optical axis direction.

The first ball group BG1 and the second ball group BG2 may be disposed to be spaced apart from each other in a direction perpendicular to the optical axis.

For example, the number of balls in the first ball group BG1 and the number of balls in the second ball group BG2 may be equal to each other.

According to another example embodiment of the present disclosure, as illustrated in FIG. 13, the number of balls of the first ball group BG1 and the number of balls of the second ball group BG2 may be different from each other.

For example, the first ball group BG1 may include two or more balls disposed in the optical axis direction, and the second ball group BG2 may include a smaller number of balls than the number of balls included in the first ball group BG1.

On the assumption that the number of balls included in the first ball group BG1 and the number of balls included in the second ball group BG2 are different from each other, the number of balls included in each ball member may be changed. Hereinafter, for convenience of description, an example embodiment will be described based on a case in which the first ball group BG1 includes three balls, and the second ball group BG2 includes two balls.

Among the three balls included in the first ball group BG1, two outermost balls in a direction, parallel to the optical axis, may have equal diameters, and one ball disposed therebetween may have a diameter less than those of the outermost balls.

For example, among a plurality of balls included in the first ball group BG1, two outermost balls in a direction, parallel to the optical axis, may have a first diameter, and one ball disposed between the outermost balls may have a second diameter, and the first diameter may be greater than the second diameter.

The two balls included in the second ball group BG2 may have equal diameters. For example, the two balls included in the second ball group BG2 may have a third diameter.

In addition, the first diameter and the third diameter may be equal to each other. Here, diameters being equal to each other may include not only a case in which the diameters are physically equal to each other, but also a case including a manufacturing tolerance.

A distance between centers of the outermost balls in a direction, parallel to the optical axis, among the plurality of balls included in the first ball group BG1 and a distance between centers of the outermost balls in a direction, parallel to the optical axis, among the plurality of balls included in the second ball group BG2 may be different from each other.

In order for the carrier 300 to move to be parallel to the optical axis when moving in the optical axis direction, a central point CP of the attractive force acting between the driving magnet 410 and the first yoke 425 may need to be positioned within a support region A connecting contact points between the first ball member B1 and the carrier 300.

When the central point CP of the attractive force deviates from the support region A, a position of the carrier 300 may be misaligned during movement thereof, and tilting may occur. Accordingly, it may be necessary to form the support region A as wide as possible.

In another example embodiment of the present disclosure, some balls, among the plurality of balls of the first ball member B1, may be intentionally formed to have diameters less than those of the remaining balls. In this case, balls having larger diameters, among the plurality of balls, may be intentionally brought into contact with the carrier 300.

Two balls, among the three balls included in the first ball group BG1, may have diameters greater than that of a remaining one ball, such that the two balls of the first ball group BG1 may be in contact with the carrier 300. In addition, the two balls of the second ball group BG2 may have equal diameters, and the two balls of the second ball group BG2 may be in contact with the carrier 300.

Accordingly, as illustrated in FIG. 13, when viewed in one direction, perpendicular to the optical axis, the first ball member B1 may be in contact with the carrier 300 at four points. The support region A, connecting the contact points to each other, may have a rectangular shape.

As a result, the support region A may be formed to be relatively wide, and accordingly, the center point CP of the attractive force acting between the driving magnet 410 and the first yoke 425 may be stably positioned within the support region A. That is, driving stability during focus adjustment may be maintained.

The focus adjustment portion may include a first electronic device portion 405. For example, the first electronic device portion 405 may include a first drive IC 460 controlling current, and a first multilayer ceramic condenser (MLCC) 450 for smooth current flow and signal transmission.

Current applied to the driving coil 430 may be controlled by the first drive IC 460.

For example, the first drive IC 460 may include a Hall sensor, but the present invention is not limited thereto. The Hall sensor may be provided as a component separate from the first drive IC 460.

The Hall sensor may detect a position of a counterpart component in the optical axis direction, based on a change in magnetic field intensity resulting from a positional change of the driving magnet 410, and the first drive IC 460 may limit the allowable current for the driving coil 430, based on a Hall sensor signal.

The first drive IC 460 may be spaced apart from the driving coil 430 in a direction perpendicular to the optical axis direction, and may be disposed in the housing 120.

The first MLCC 450 may be disposed to oppose the driving magnet 410 within the driving coil 430.

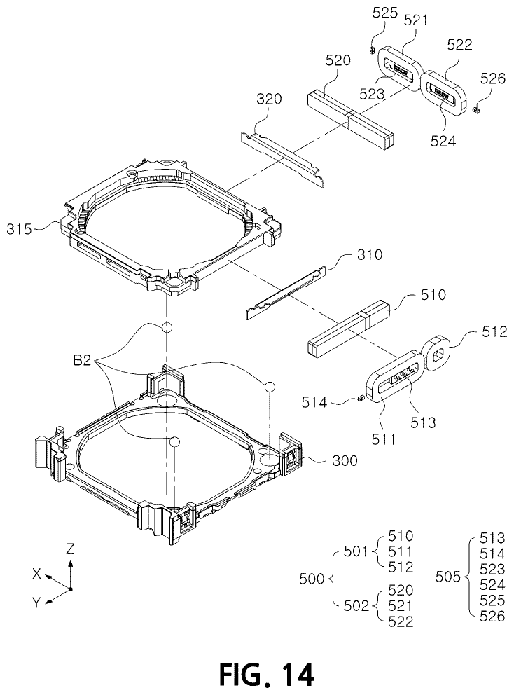

FIG. 14 is an exploded perspective view of an image stabilization portion according to an example embodiment of the present disclosure.

For example, the present disclosure may include an image stabilization portion moving a lens module 200 in a direction perpendicular to the optical axis.

The image stabilization portion may include a lens holder 315, and a second driving portion 500 generating driving force to move the lens holder 315 in a direction perpendicular to the optical axis.

The second driving portion 500 may include a plurality of magnets, and a plurality of coils disposed on a substrate 600.

The second driving portion 500 may include a first magnet 510, and a first sub-driving portion 501 including a first coil 511 and a second coil 512.

The second driving portion 500 may include a second magnet 520, and a second sub-driving portion 502 including a third coil 521 and a fourth coil 522.

The first sub-driving portion 501 may generate driving force in a first axis (X-axis) direction, and the second sub-driving portion 502 may generate driving force in a second axis (Y-axis) direction.

The first magnet 510 may be disposed to oppose the first coil 511 and the second coil 512 in a direction perpendicular to the optical axis. The second magnet 520 may be disposed to oppose the third coil 521 and the fourth coil 522 in a direction perpendicular to the optical axis.

The first magnet 510 may be disposed to oppose both the first coil 511 and the second coil 512 in a direction perpendicular to the optical axis. One surface of the first magnet 510, opposing one of the first coil 511 and the second coil 512, may be magnetized to have an N pole or an S pole. In this case, one surface of the first magnet 510, opposing the other one, may be magnetized to have an opposite polarity.

The first coil 511 and the second coil 512 may be fixed members disposed on the substrate 600 and fixed to the housing 120, and the first magnet 510 may be a moving member moving in a state of being disposed in the lens holder 315.

The first magnet 510 may be disposed to oppose a second press 310 inserted into the lens holder 315. For example, the first magnet 510 may be in direct contact with the second press 310 and coupled to the second press 310.

The second press 310 may be formed of a magnetic material. Accordingly, an attractive force may be generated between the second press 310 and the first magnet 510.

When power is applied to the first coil 511 and the second coil 512, electromagnetic force between the first coil 511 and the second coil 512 may move the first magnet 510 and the lens holder 315 in the first axis (X-axis) direction, perpendicular to the optical axis.

A polarized length of the first magnet 510 opposing the first coil 511 may be greater than a polarized length of the first magnet 510 opposing the second coil 512. Accordingly, leakage of magnetic flux may be prevented.

The second magnet 520 may be disposed to oppose both the third coil 521 and the fourth coil 522 in a direction perpendicular to the optical axis. One surface of the second magnet 520, opposing one of the third coil 521 and the fourth coil 522, may be magnetized to have an N pole or an S pole. In this case, one surface of the second magnet 520, opposing the other one, may be magnetized to have an opposite polarity.

The third coil 521 and the fourth coil 522 may be fixed members disposed on the substrate 600 and fixed to the housing 120, and the second magnet 520 may be a moving member moving in a state of being disposed in the lens holder 315.

The second magnet 520 may be disposed to oppose a third press 320 inserted into the lens holder 315. For example, the second magnet 520 may be in direct contact with the third press 320 and coupled to the third press 320.

The third press 320 may be formed of a magnetic material. Accordingly, an attractive force may be generated between the third press 320 and the second magnet 520.

When power is applied to the third coil 521 and the fourth coil 522, electromagnetic force between the third coil 521 and the fourth coil 522 may move the second magnet 520 and the lens holder 315 in the second axis (Y-axis) direction, perpendicular to the optical axis.

The image stabilization portion may include a plurality of ball members supporting the lens holder 315.

The plurality of ball members may function to guide movement of the lens holder 315 and the lens barrel 210 during an image stabilization process. In addition, the plurality of ball members may perform a function of maintaining a distance between the carrier 300 and the lens holder 315.

The plurality of ball members may include a second ball member B2.

The second ball member B2 may guide movement of the lens holder 315 in the first axis (X-axis) direction and the second axis (Y-axis) direction.

The image stabilization portion may include a second electronic device portion 505. For example, the second electronic device portion 505 may include second drive ICs 513, 523, and 524 controlling current, and second MLCCs 514, 525, and 526 for smooth current flow and signal transmission.

The second drive ICs 513, 523, and 524, and the second MLCCs 514, 525, and 526 may be provided as a plurality of second drive ICs 513, 523, and 524 and a plurality of second MLCCs 514, 525, and 526, respectively.

Current applied to a plurality of coils may be controlled by the second drive ICs 513, 523, and 524.

For example, the second drive ICs 513, 523, and 524 may include a plurality of hall sensors. However, the present invention is not limited thereto, and a plurality of hall sensors may be provided as components separate from each of the second drive ICs 513, 523, and 524.

The plurality of Hall sensors may detect positions of counterpart components in the optical axis direction, based on a change in magnetic field intensity resulting from positional changes of the first magnet 510 and the second magnet 520, and the second drive ICs 513, 523, and 524 may limit allowable current for the plurality of coils, based on a plurality of Hall sensor signals.

The second drive ICs 513, 523, and 524 may be spaced apart from the plurality of coils in a direction, perpendicular to the optical axis direction, and may be disposed in the housing 120.

The second MLCCs 514, 525, and 526 may be disposed to oppose the first magnet 510 or the second magnet 520 within the plurality of coils, respectively.

The second drive ICs 513, 523, and 524 may include at least three drive ICs. Similarly, the second MLCCs 514, 525, and 526 may include at least three MLCCs.

An aspect of the present disclosure is to maintain the perpendicularity of a ball rolling portion even when a carrier is coupled to other members.

According to example embodiments of the present disclosure, a lens driving apparatus and a camera module including the same may maintain perpendicularity of a ball rolling portion of a carrier.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens driving apparatus comprising:
a lens module comprising a plurality of lenses;
a carrier disposed in a housing and configured to move together with the lens module in an optical axis direction;
a stopper coupled to the carrier; and
a first ball member disposed between the housing and the carrier,
wherein the carrier comprises:
a first sidewall extending in the optical axis direction, wherein the first ball member is disposed on the first sidewall;
a second sidewall extending from the first sidewall, the second sidewall having one surface to which the stopper is coupled; and
a reinforcing portion such that a thickness of a portion of the second sidewall to which the stopper is coupled is greater on a side closer to the first sidewall than on a side farther from the first sidewall.

2. The lens driving apparatus of claim 1, wherein the reinforcing portion comprises a first chamfered surface oblique to one surface of the carrier on which the first ball member is disposed, and to another surface of the carrier to which the stopper is coupled.

3. The lens driving apparatus of claim 1, wherein
the reinforcing portion comprises:
a first reinforcing surface extending from one end of the reinforcing portion toward the housing; and
a second reinforcing surface extending from the other end of the reinforcing portion toward the housing, and
the first reinforcing surface and the second reinforcing surface are perpendicular to each other within the carrier.

4. The lens driving apparatus of claim 2, wherein
the lens module comprises a lens holder disposed on the carrier, and
the lens holder comprises a cutout portion opposing the reinforcing portion.

5. The lens driving apparatus of claim 4, wherein
the cutout portion comprises a second chamfered surface opposing the first chamfered surface.

6. A lens driving apparatus comprising:
a lens module comprising a plurality of lenses;
a carrier disposed in a housing and configured to move together with the lens module in an optical axis direction; and
a stopper coupled to the carrier,
wherein the carrier comprises a rigid member disposed to overlap a portion of the carrier to which the stopper is coupled, the rigid member having an extension portion extending in the optical axis direction.

7. The lens driving apparatus of claim 6, wherein a material of the rigid member has a higher structural rigidity than a material of the carrier, and is disposed to at least partially overlap the portion of the carrier to which the stopper is coupled.

8. The lens driving apparatus of claim 6, wherein
the rigid member comprises a bottom portion disposed on a bottom surface of the carrier, and
the extension portion is bent and extends from the bottom portion in the optical axis direction.

9. The lens driving apparatus of claim 8, wherein a length of the extension portion in the optical axis direction corresponds to a length of the carrier extending from the bottom surface of the carrier in the optical axis direction.

10. The lens driving apparatus of claim 6, wherein
the extension portion is disposed to be spaced apart from each other in one direction, perpendicular to the optical axis direction, and
the extension portion further comprises a plurality of extension portions disposed to be spaced apart from each other in another direction, perpendicular to both the optical axis direction and the one direction.

11. The lens driving apparatus of claim 6, wherein
the stopper is coupled to a stopper coupling portion disposed on the carrier, and
a length of the extension portion in a width direction, perpendicular to the optical axis direction, is less than a length of the stopper coupling portion in the width direction.

12. The lens driving apparatus of claim 11, wherein
the carrier comprises a first ball rolling portion having a first ball member disposed between one surface of the housing and one surface of the carrier opposing each other,
the stopper coupling portion is disposed on the other surface of the carrier, adjacent to the one surface of the carrier, and
a center of the length of the extension portion in the width direction is disposed to be away from the first ball rolling portion with respect to a center of the length of the stopper coupling portion in the width direction.

13. A camera module comprising:
a carrier accommodating a lens module; and
a focus adjustment portion configured to drive the carrier in an optical axis direction,
wherein a first ball rolling portion and a stopper coupling portion are disposed on different side surfaces of the carrier, and
wherein the carrier comprises
a reinforcing portion disposed at an inner corner of the carrier at which the first ball rolling portion and the stopper coupling portion meet each other, and a rigid member having an extension portion disposed to overlap the stopper coupling portion.

14. The camera module of claim 13, wherein
the lens module comprises a lens barrel in which a plurality of lenses are disposed, and a lens holder to which the lens barrel is coupled, and
the lens holder comprises a cutout portion disposed to oppose the reinforcing portion.

15. The camera module of claim 13, wherein
the rigid member comprises a metallic material and a bottom portion disposed on a bottom surface of the carrier, and
the extension portion is bent and extends from the bottom portion in the optical axis direction.

16. The camera module of claim 13, wherein a center of a length of the extension portion in a width direction, perpendicular to the optical axis direction, is disposed to be away from the first ball rolling portion with respect to a center of a length of the stopper coupling portion in the width direction.

17. The camera module of claim 13, further comprising:
an image stabilization portion configured to drive the lens module in a direction perpendicular to the optical axis direction.

18. The camera module of claim 17, wherein
the image stabilization portion further comprises a plurality of coils disposed in the housing, and a plurality of electronic devices, and
the plurality of electronic devices comprise at least three position sensors.
